(19) United States
(12) Patent Application Publication
(10) Pub. No.: US 2016/0314640 A1
(43) Pub. Date: Oct. 27, 2016

(54) PREPAID CURRENCY CARD VENDING MACHINE

(71) Applicant: MasterCard International Incorporated, Purchase, NY (US)

(72) Inventors: Robert Ward, Braintree (GB); Simon Wright-Lakin, Bourne (GB); William Kemp, Deeping St. James (GB)

(21) Appl. No.: 15/067,331

(22) Filed: Mar. 11, 2016

(30) Foreign Application Priority Data
Mar. 13, 2015 (GB) 1504295.5

(51) Int. Cl. G07F 7/08; G06Q 20/20; G06K 19/07; G06Q 20/34; G06Q 20/32; G07F 7/10; G06Q 20/28

(52) U.S. Cl. CPC G07F 7/0886; G07F 7/1008; G06Q 20/202; G06Q 20/28; G06Q 20/3433; G06Q 20/3276; G06K 19/0723; G06Q 20/3278; G06Q 20/352

(57) ABSTRACT

According to one aspect there is provided a prepaid currency card (PPCC) vending machine comprising: PPCC storage; an electronic point of sale terminal (POS) configured to take payment from a user and initiate transmission of a payment received message, said message comprising a payment identification code (PIC); a controller configured to receive said payment received message; a card identifier configured to read an identification code (ID) of a PPCC held in a position in PPCC storage which is next to be dispensed from; a PPCC dispenser configured to dispense a PPCC from said PPCC storage in response to receipt of a dispense command from said controller; and a transmitter configured to transmit said PIC together with said card ID to a card issuer server. According to a second aspect there is provided a method for issuing a PPCC from such a vending machine.

### CROSS-REFERENCE TO RELATED APPLICATIONS

This application claims foreign priority to United Kingdom Patent Application No. 1504295.5, filed 13 Mar. 2015, the complete disclosure of which is expressly incorporated herein by reference in its entirety for all purposes.

### FIELD OF THE INVENTION

The present disclosure relates to a vending machine for prepaid currency cards and methods and systems of making use of such a machine.

### BACKGROUND

Bureau de Change kiosks, particularly those in airports, can charge high currency conversion commissions and often have queues. In addition, travellers can be reluctant to carry large sums of foreign currency with them when they travel abroad due to the risk of loss or theft. Payment cards such as debit and credit cards can often be used at foreign automatic teller machines (ATMs) but banks tend to charge high commissions for these transactions.

Prepaid currency cards (PPCCs) are therefore available for purchase. These can be bought on arrival in a foreign country at, for example a kiosk, newsagent or supermarket having a traditional point of sale terminal (POS) using cash or a payment card. PPCCs may come pre-loaded with a predetermined quantity of currency or may require an initial loading, which may be a service provided at the POS where the card is purchased (using cash or a payment card) or may be possible by means of a telephone or online transaction using a payment card. Subsequent top-ups may be possible in a similar manner at various stores or by means of telephone or online payments.

PPCCs may be single currency or multi-currency, allowing the same card to be used throughout a tour of a region where multiple currencies are used.

PPCCs are typically displayed in stores using j-hook style end of aisle displays. However, being pocket-sized and seen to represent cash value (even if, in reality, the initial balance loaded on each card is zero), they are attractive to shoplifters. The end of aisle position can also expose cards to damage or loss prior to sale.

Further, if a user loses a card or has it stolen from them after purchase, they lose the remaining balance on the card in addition to the cost of the card itself.

An improved means of dispensing PPCCs is needed.

### SUMMARY

According to a first aspect there is provided a prepaid currency card (PPCC) vending machine comprising: PPCC storage; an electronic point of sale terminal (POS) configured to take payment from a user and initiate transmission of a payment received message, said message comprising a payment identification code (PIC); a controller configured to receive said payment received message; a card identifier configured to read an identification code (ID) of a PPCC held in a position in PPCC storage which is next to be dispensed from; a PPCC dispenser configured to dispense a PPCC from said PPCC storage in response to receipt of a dispense command from said controller; and a transmitter configured to transmit said PIC together with said card ID to a card issuer server.

Said card identifier could comprise a barcode or quick response (QR) code scanner configured to read a code on said PPCC or packaging of the PPCC.

Said card identifier could comprise an RFID reader configured to read a tag comprised in said PPCC. Said card identifier could comprise an NFC reader configured to read a tag comprised in packaging of the PPCC. Said card identifier could comprise an RFID reader configured to read a tag comprised in said PPCC. Said card identifier could comprise an NFC reader configured to read a tag comprised in packaging of the PPCC.

The PPCC could be configured for contactless payment using said tag.

The vending machine could further comprise printing or embossing apparatus.

The vending machine could further comprise a user interface device configured to provide a user with currency exchange and/or commission rates.

Said PPCC storage could comprise runners configured for a hook comprised in packaging of the PPCC to hang on.

The vending machine could further comprise a camera or scanner configured to capture images for Know Your Customer (KYC) checks.

According to a second aspect there is provided a system comprising the vending machine according to the first aspect, a processing platform and a network through which the vending machine and processing platform can communicate.

The system could further comprise a user device having a camera or scanner. Said camera or scanner could be configured to capture a quick response (QR) code on the PPCC or packaging of the PPCC. Data obtained therefrom could be used in a PPCC registration or activation process.

The system could further comprise a user device having a camera or scanner configured to capture images for Know Your Customer (KYC) checks.

Said processing platform could monitor the number of PPCCs comprised in the vending machine. It could automatically initiate re-stocking of the vending machine when said number falls below a predetermined level.

The system could further comprise a product manager digital dashboard connected to said processing platform for monitoring one or more of: spending on the PPCC, PPCC registration, PPCC sales and PPCC stock levels.

According to a third aspect there is provided a method for issuing a prepaid currency card (PPCC) from a vending machine, said method comprising: taking payment from a user and initiating transmission of a payment received message to a controller, said message comprising a payment identification code (PIC); reading an identification code (ID) of a PPCC held in a position in PPCC storage which is next to be dispensed from; dispensing a PPCC from said PPCC storage in response to receipt of a dispense command from said controller; and transmitting said PIC together with said card ID to a card issuer server.

According to a fourth aspect there is provided a vending machine substantially as described herein with reference to the accompanying drawings.

According to a fifth aspect there is provided a system substantially as described herein with reference to the accompanying drawings.

According to a sixth aspect there is provided a method substantially as described herein with reference to the accompanying drawings.

### BRIEF DESCRIPTION OF THE DRAWINGS

Implementations will now be described in detail, by way of example only, with reference to the accompanying drawings, in which:

FIG. 1 shows an example PPCC vending machine;

FIG. 2 illustrates an example PPCC package;

FIG. 3 is a flowchart of an example method of issuing a PPCC from a vending machine;

FIG. 4 is a schematic of an example system for issuing PPCCs through a vending machine;

FIG. 5 is a process flow diagram illustrating processes within an example system in which PPCCs are manufactured, distributed to vending machines, purchased and used by consumers;

FIGS. 6A and 6B illustrate an example process for adding currencies to a PPCC; and

FIGS. 7A and 7B illustrate another example process for adding currencies to a PPCC.

### DETAILED DESCRIPTION

The following description is presented to enable any person skilled in the art to make and use the system, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

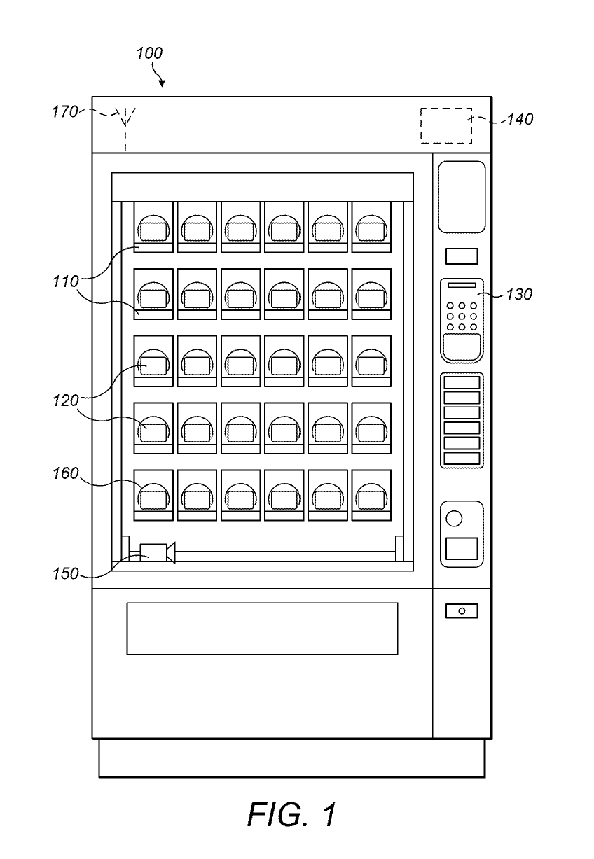

FIG. 1 is a schematic diagram of an example PPCC vending machine 100.

The vending machine comprises PPCC storage 110, for example in the form of shelves, racks, tracks or runners suitable for storing multiple PPCCs 120.

There is also an electronic POS 130 configured to take payment from a user. The electronic POS could comprise one or more of:
a coin and/or note slot equipped with apparatus for detecting inserted cash and determining its value,
a magnetic stripe reader through which a payment card can be swiped,
a tablet, touch pad or touchscreen onto which a signature can be drawn with a fingernail or an attached stylus,
a smartcard chip reader into which a payment card can be inserted,
a keypad or touchscreen into which a personal identification number (PIN) or other password can be entered, and
an RFID reader and/or NFC device configured to read an RFID or NFC tag in a payment card or mobile device such as a smartphone or tablet computer.

POS 130 also initiates transmission of a payment received message when it detects that payment has been made, said message comprising a payment identification code (PIC). The payment received message could be sent directly to a controller 140 of the vending machine, configured to control card dispensing apparatus. Alternatively it could be sent to an external system, for example a card issuer or bank server, for any required checks to be performed. For example, if payment for the PPCC is made using a payment card or online transfer, a check could be made on the identity of the account holder to ensure they are not barred from using their account or from travelling to the location of the vending machine (i.e. the country or state in which it is located).

A card identifier 150 is also comprised in the vending machine. This card identifier is configured to read an identification code (ID) of a PPCC held in a position in PPCC storage which is next to be emptied. Card identifier 150 could comprise one or more of:
a camera/scanner and a processor configured for optical character recognition (OCR) configured to read a card ID in the form of an alphanumeric text string printed or embossed onto the PPCC itself or its packaging;
a barcode/quick response (QR) code scanner configured to read a code on the PPCC itself or its packaging;
a magnetic stripe reader through which the PPCC is automatically swiped;
a smart card chip reader in which the PPCC is automatically inserted;
an RFID or NFC reader which the PPCC is automatically brought into proximity with; and
a computer system comprising a processor and a memory configured to store a list of the IDs of PPCCs loaded into the vending machine (the PPCCs being loaded into and dispensed from the vending machine in a predetermined order) and a counter to keep track of how many cards have been dispensed since the last time the vending machine was re-stocked.

The vending machine further comprises a PPCC dispenser 160 configured to dispense a PPCC from the PPCC storage 110 in response to receipt of a dispense command from the controller 140, issued following receipt by the controller of a payment received message, for example from the POS 130 and/or a payment authorised message, for example from a remote system such as a card issuer or bank server.

The PPCC dispenser 160 can comprise any apparatus suitable for selecting a PPCC and making it accessible to a user. For example, a rotating coil in which cards are loaded could be caused to rotate such that the cards move forwards and the front card drops into a collection bin accessible to the user. Alternatively, a robotic claw could move to the location of the card to be dispensed, grip it, move it to a position over a collection bin and release it. As another example, each card could be located in an individual locked compartment, and when one is to be dispensed, the lock is automatically opened and some indication is provided to the user of which compartment to take the card from (e.g. the compartment door could pop open, a light on the compartment could flash or a compartment identifier e.g. formed of a column number and row letter, could be displayed on a screen).

Optionally, the PPCC dispenser could also comprise printing or embossing apparatus so that information provided by the user by means of a user interface device, or provided to the vending machine via connection to a remote system such as a card issuer or bank server, can be added to a PPCC before it is made available to the user. For example, the user's name could be added to the card. In order to use the card at a POS the user may have to provide identification, such as a passport or driving license, which matches the name on the card. Alternatively or additionally, a copy of the user's signature (whether retrieved from a remote database or provided by the user by writing with a stylus attached to the vending machine or e.g. their fingernail or a pen on a tablet pad/touchscreen on the vending machine. This signature could then be checked against one made on a receipt by the user in order to make purchases with the card at POSs. Other details of the user or the way in which the card is set up (e.g. a currency or currencies loaded onto it) could also be added in this manner.

Targeted advertisements could also be added to the card by the printing or embossing apparatus. They could be targeted on a temporal and/or geographical basis, for example advertising a limited-time offer at a particular business in the vicinity of the vending machine's location (e.g. 2 for 1 entry to a local theme park until the end of the month). Alternatively or additionally they could be targeted at a particular user, making use of information provided by the user via a user interface of the vending machine during the PPCC purchase process and/or provided from a remote database which identifies the user or a payment card or account used to purchase the PPCC and associated information such as age, gender, interests and common purchases/commonly frequented establishments.

The user could alternatively or additionally be presented with a list of current available offers during the PPCC purchase process. They could then select one or more of these by means of a user interface of the vending machine. These offers could be printed or embossed onto the PPCC and/or stored on electronic data storage means of the PPCC (e.g. an RFID or NFC tag, a smartcard chip or magnetic stripe) prior to dispensing so that the card can be used as a voucher. Identifiers of the offers could be alternatively or additionally stored electronically, on electronic data storage means of the PPCC itself or remotely, such that when the PPCC is used to make a purchase to which the offers can be applied they are applied automatically, or the user can be alerted to the fact that they can choose to apply an offer to the transaction.

The vending machine 100 also comprises a transmitter 170 configured to transmit the PIC together with the card ID to a card issuer server. This either activates the PPCC or primes it for activation by the user at a later time, for example using a smartphone app, a website or over the telephone. The transmitter could be wired or wireless. It could provide a connection to the card issuer server over a network such as the internet or a cellular network. Transmitter 170 could be part of a transceiver and could be used for other communications such as remote access to various databases as discussed above. The card issuer can keep track of stock levels in individual vending machines by recording dates of PPCC purchases so that machines can be re-filled as necessary, with re-fills being automatically scheduled.

As discussed above, vending machine 100 could comprise one or more user interface devices. One of these, or a separate user interface device could optionally be provided to inform a user of currency exchange and/or commission rates. For example, the current rates could be advertised on a large screen so that potential customers can determine whether they wish to join a queue for the vending machine. Alternatively, a smaller screen and/or a speaker could provide a user with one or more specific rates when requested.

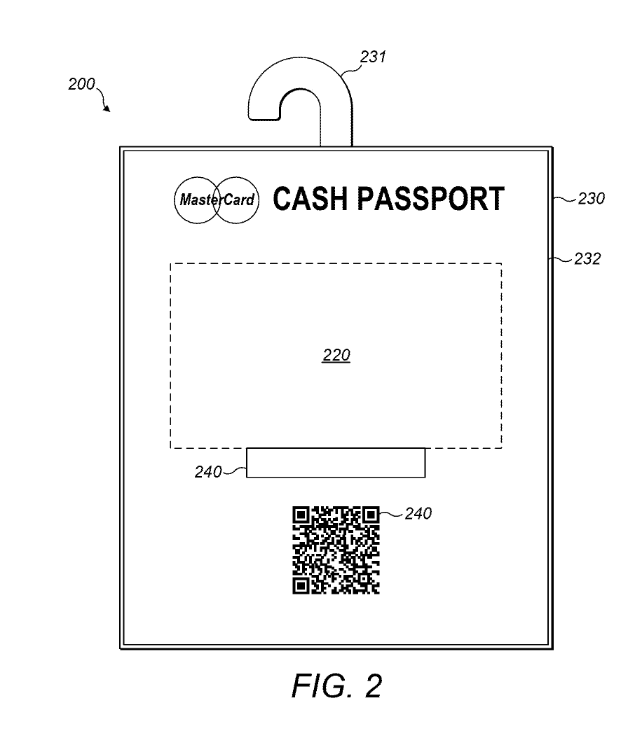

FIG. 2 is an illustration of an example PPCC package 200 comprising a PPCC 220 in packaging 230 adapted for storage in a vending machine such as PPCC vending machine 100.

In the example shown, packaging 230 comprises a J-hook 231 (for example made of plastic) affixed to a backing card 232 (for example made of thin cardboard). The J-hook allows the PPCC package to be hung on a runner in a vending machine (or, if cards packaged in the same factory are destined for both vending machines and traditional end of aisle displays, in a store display).

In the example shown, packaging 230 comprises a card identification code (ID) 240. Alternatively, card ID 240 could be comprised in PPCC 220. Card ID 240 could be, for example, an alphanumeric text string printed or embossed onto the PPCC 220, backing card 232 or any other visibly exposed part of packaging 230. Alternatively or additionally, it could be represented by a barcode or QR code printed onto the PPCC 220, backing card 232 or any other visibly exposed part of packaging 230. Alternatively, card ID 240 could be stored in electronic data storage means comprised in the PPCC 220 or packaging 230. For example, it could be stored in a magnetic stripe, a smart card chip, a radio frequency identification (RFID) tag or a near field communication (NFC) chip. If the card ID 240 is stored in electronic data storage means comprised in the PPCC 220, these electronic data storage means could double as those employed to identify the card to a payment infrastructure when used in POS transactions.

PPCC 220 and/or packaging 230 may optionally comprise other features such as one or more of:
a card issuer logo,
text or symbols to indicate the currency or currencies that can be loaded onto the PPCC,
a web address or QR code providing a link to a website or mobile application download through which the card can be registered and/or loaded/topped-up,
a telephone number to call to register and/or load and/or top-up the card, and instructions for registering and/or loading and/or topping-up the card.

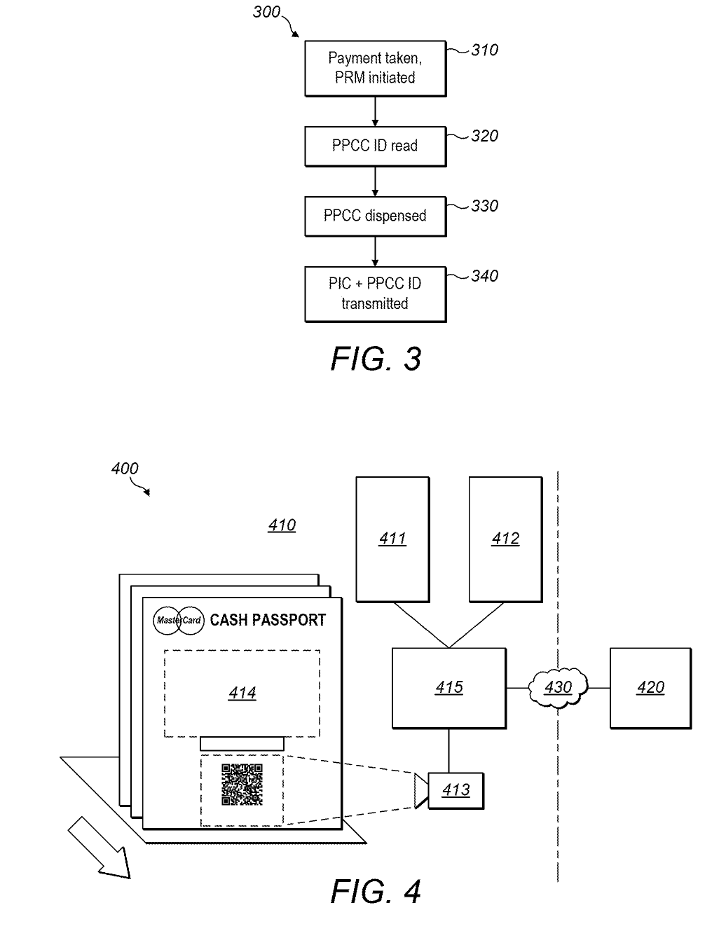

FIG. 3 is a flowchart of a method 300 of issuing a PPCC from a vending machine. At 310 payment is taken from a user and transmission of a payment received message to a controller is initiated, said message comprising a payment identification code (PIC). At 320, an identification code (ID) of a PPCC held in a position in PPCC storage which is next to be emptied is read. At 330, a PPCC from said PPCC storage is dispensed in response to receipt of a dispense command from the controller. At 340, the PIC is transmitted together with the card ID to a card issuer server.

Know Your Customer (KYC) checks may be legally required in some countries to prevent money laundering. These could be performed before or after a PPCC is dispensed. If performed before the card is dispensed, in the event of a user failing the checks, the cost of the card can be immediately refunded in the same form as the original payment. If performed after the card is dispensed (e.g. as part of a registration/activation process), the purchase process at the vending machine can be quicker, preventing queues from building up, e.g. at an airport in an area passengers pass through when disembarking from a flight.

KYC checks may comprise identification checks. The vending machine could comprise a camera or scanner to capture images from passports, driving licenses etc. for these purposes. Alternatively, if KYC checks are performed post-PPCC dispensing, the camera of a smartphone or tablet could be used to capture such images and a registration/activation app or webpage could provide tools to integrate use of the camera for this purpose.

A further registration or activation step may be required of the user before a dispensed card can be used. This may be done over the telephone, e.g. using an automated service which records details entered using a telephone keypad or spoken so as to be understood by voice recognition software. Alternatively, this could be done through a webpage or a specific app. One or more of the PPCC, its packaging (e.g. backing card), a receipt issued with the PPCC and the vending machine could display an appropriate telephone number with instructions to call to activate the card, or a web address together with instructions to go there to fill our an online form or download an app from that web page to register the card.

Registration or activation could comprise provision of information such as one or more of name, address, date of birth, ID (e.g. passport or driving license) number etc.

FIG. 4 is a schematic of a system 400 for issuing PPCCs through a vending machine. This system comprises the vending machine 410 and a processing platform 420 which can communicate with one another through a network 430, such as the internet or a cellular network.

The vending machine 410 comprises a consumer interface 411 which can, for example, provide currency exchange rates, allow user selection of currencies and confirm the details of a transaction before payment is taken. The consumer interface 411 could comprise any suitable user interface device or combination of user interface devices.

For example, the consumer interface could comprise one or more of: a screen (which could be a touchscreen), a speaker for issuing computer-generated or pre-recorded speech or warning/alert/confirmation sounds, a refreshable braille display, a touchpad (whether for finger or stylus entry), a stylus, a keypad, one or more selection buttons, a click-wheel, a mouse, a joystick and a microphone.

Also comprised in the vending machine 410 is payment terminal, or POS, 412. This takes payment from a user in any of the manners described above and assigns the payment a PIC.

The vending machine 410 further comprises a card identifier 413 such as a camera or wireless reader module to read the ID of the PPCC 414 that is next to be dispensed, which can be done for example in any of the manners described above.

The consumer interface 411, payment terminal 412 and camera/wireless reader module 413 all communicate with the vending machine processor 415. Once the processor 415 has received user input such as currency selection from the consumer interface 411, the PIC from the payment terminal 412 and the PPCC ID from the card identifier 413 it allocates the PIC to the currencies and associated currency amounts and exchange rates, assigns the card ID to the PIC and sends information to the processing platform 420.

The processing platform 420 is resident on one or more computer systems, e.g. servers, of the PPCC issuer. It stores PIC and card ID pairs ready for PPCC activation/registration. It may also store a change in status of the card when it is activated and any details obtained about the user. It may also track stock levels in individual vending machines, provide exchange rates to the vending machines(e.g. daily). It could also monitor usage of the PPCC.

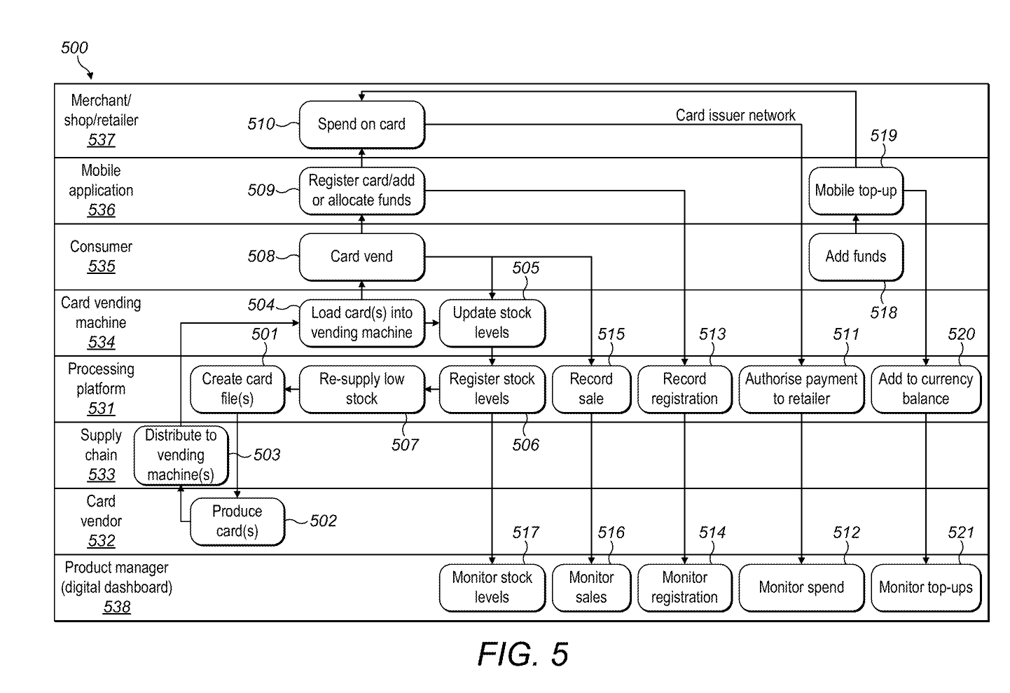

FIG. 5 is a process flow diagram illustrating processes within a system 500 in which PPCCs are manufactured, distributed to vending machines, purchased and used by consumers.

At 501, one or more card files are created on a processing platform 531. Creating a card file sets up a record comprising a PPCC ID. At 502, the card file(s) are sent to card vendor 532 to create the card(s). The physical card(s) are then manufactured ready for distribution to the vending machine by the supply chain 533 at 503. At 504, distributers load the card(s) into the vending machine 534 and the stock levels are updated at 505. At 506, stock levels are registered on the processing platform 531. The processing platform monitors the level of cards at each location and triggers a new file when stocks are running below a predetermined level at 507.

At 508, the vending machine 534 vends a PPCC to a consumer 535. The consumer then uses a mobile application 536 to register the PPCC at 509. Funds can also be added to the card at this stage if not already done using the vending machine POS.

When they wish to spend funds on the PPCC, the consumer presents the PPCC to a POS of a merchant 537 at 510. Alternatively, the consumer could enter the card details into a merchant website. The merchant POS/website then communicates with the card issuer's processing platform 531 using the card issuer network in order to authorise payment to the merchant at 511.

The card issuer may optionally have a product manager digital dashboard 538 which can be used to monitor spending on the PPCC at 512 by receiving confirmation of authorised payments from the processing platform 531. The dashboard can also be used to monitor other aspects of the system. For example, PPCC registration can be recorded by the processing platform 531 at 513 and this can be monitored by the product manager 538 at 514. This allows the product manager to compare the number of cards sold with the number of cards registered. Sales of PPCCs from the vending machine could also be recorded by the processing platform 531 at 515. This allows

PPCC sales to be monitored using dashboard 538 at 516. Stock levels registered by the processing platform 531 at 506 can also be monitored using dashboard 538 at 517.

A PPCC top-up process is shown on the right hand side of FIG. 5. At 518 consumer 535 adds funds. The top-up is then effected by mobile application 536 at 519, causing the processing platform 531 to add to the PPCC currency balance at 520. This can optionally be monitored on dashboard 538 at 521. The consumer can then spend the new balance with a merchant 537 at 510 as described above.

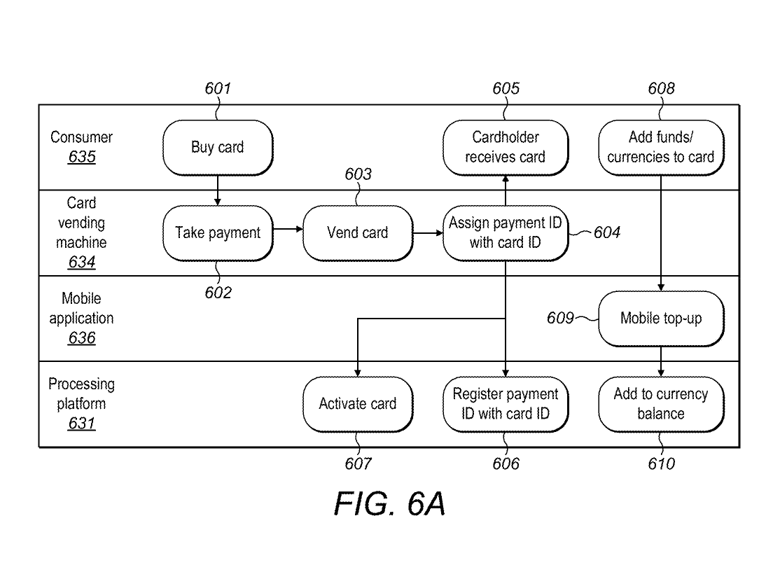

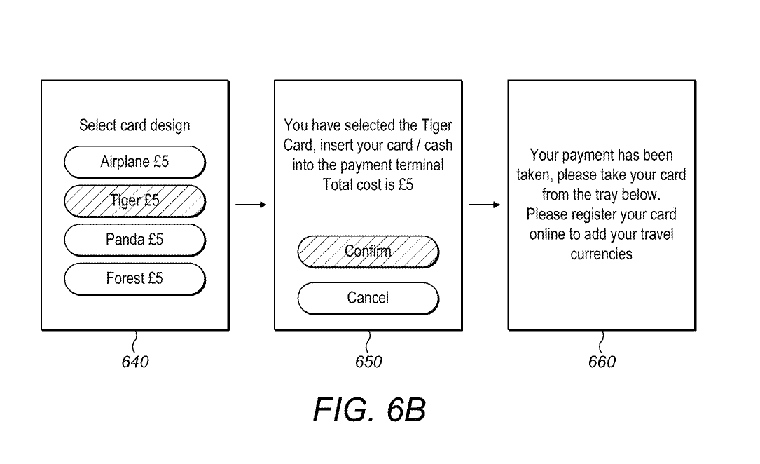

As mentioned previously, though the consumer will have to pay for the PPCC itself in order for it to be vended to them, they need not add any currencies to it at that point; this can be done later. FIG. 6A illustrates that process.

At 601, consumer 635 requests a PPCC. At 602, the vending machine 634 takes payment and at 603 it selects a card for vending. At 604 the vending machine 634 links the PIC with the card ID. This triggers: (i) receipt of the PPCC by the consumer 625 at 605; (ii) registration of the PIC with the card ID by the processing platform 631 at 606; and (iii) activation of the PPCC by the processing platform 631 at 607.

The consumer 635 can then, at a later time, request to add funds to the PPCC at 608. This is effected by the mobile application 636 at 609 which communicates with the processing platform 631, where the new currency balance is stored at 610.

FIG. 6B shows example vending machine graphical user interfaces (GUIs) for a touchscreen that could be used for the type of PPCC vend shown in FIG. 6A. GUI 640 allows selection of a card design according to the consumer's preference. GUI 650 confirms the selection and instructs the consumer to use the POS to pay for the card. Once payment has been authorised, GUI 660 is shown, instructing the consumer to take their new PPCC and register and add currencies online.

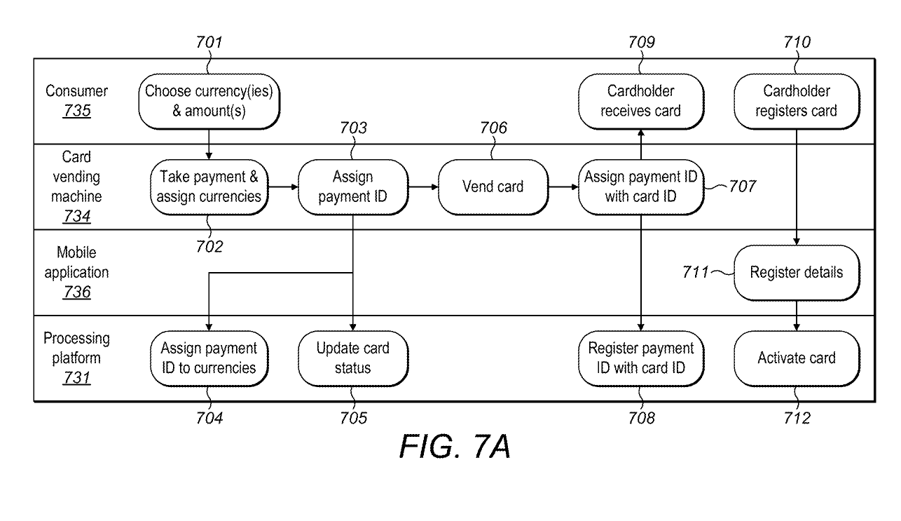

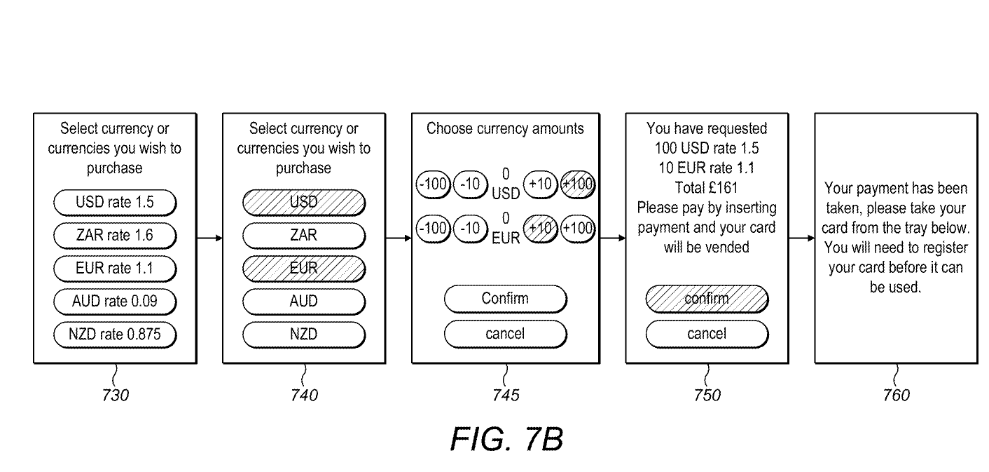

FIG. 7A illustrates an alternative process in which funds are added to the PPCC using the vending machine POS. At 701, consumer 735 chooses currencies and amounts to be added to a PPCC. At 702, vending machine 734 takes payment and assigns currencies. At 703 it assigns a PIC. At 704, the processing platform 731 receives the PIC and assigns it to currencies. At 705, processing platform 731 updates the card status.

At 706, the vending machine 734 selects a PPCC and at 707 it assigns the PIC to the PPCC ID. These are registered by the processing platform 731 at 708.

At 709 the consumer 736 receives the card.

At a later time, the consumer 735 requests registration of the PPCC at 710. Mobile application 736 registers card and optionally user details at 711. Finally, at 712 processing platform 731 activates the PPCC.

FIG. 7B shows example vending machine graphical user interfaces (GUIs) for a touchscreen that could be used for the type of PPCC vend shown in FIG. 7A. GUI 730 displays the various currencies available together with the offered exchange rates. GUI 740 allows selection of one or more currencies. GUI 745 allows selection of currency amounts. GUI 750 confirms the selection and instructs the consumer to use the POS to pay for the card. Once payment has been authorised, GUI 760 is shown, instructing the consumer to take their new PPCC and register it online.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

What is claimed is:

1. A prepaid currency card (PPCC) vending machine comprising:
PPCC storage;
an electronic point of sale terminal (POS) configured to take payment from a user and initiate transmission of a payment received message, said message comprising a payment identification code (PIC);
a controller configured to receive said payment received message;
a card identifier configured to read an identification code (ID) of a PPCC held in a position in PPCC storage which is next to be dispensed from;
a PPCC dispenser configured to dispense a PPCC from said PPCC storage in response to receipt of a dispense command from said controller; and
a transmitter configured to transmit said PIC together with said card ID to a card issuer server.

2. The vending machine of claim 1, wherein said card identifier comprises a barcode or quick response (QR) code scanner configured to read a code on said PPCC or packaging of the PPCC.

3. The vending machine of claim 1, wherein said card identifier comprises an RFID or NFC reader configured to read a tag comprised in said PPCC or packaging of the PPCC.

4. The vending machine of claim 3, wherein the PPCC is configured for contactless payment using said tag.

5. The vending machine of claim 1, further comprising printing or embossing apparatus.

6. The vending machine of claim 1, further comprising a user interface device configured to provide a user with currency exchange and/or commission rates.

7. The vending machine of claim 1, wherein said PPCC storage comprises runners configured for a hook comprised in packaging of the PPCC to hang on.

8. The vending machine of claim 1, further comprising a camera or scanner configured to capture images for Know Your Customer (KYC) checks.

9. A system comprising:
a prepaid currency card (PPCC) vending machine, in turn comprising:
PPCC storage;
an electronic point of sale terminal (POS) configured to take payment from a user and initiate transmission of a payment received message, said message comprising a payment identification code (PIC);
a controller configured to receive said payment received message;
a card identifier configured to read an identification code (ID) of a PPCC held in a position in PPCC storage which is next to be dispensed from;
a PPCC dispenser configured to dispense a PPCC from said PPCC storage in response to receipt of a dispense command from said controller; and
a transmitter configured to transmit said PIC together with said card ID to a card issuer server;
a processing platform; and
a network through which the vending machine and processing platform can communicate.

10. The system of claim 9, further comprising a user device having a camera or scanner configured to capture a quick response (QR) code on the PPCC or packaging of the PPCC and use data obtained therefrom in a PPCC registration or activation process.

11. The system of claim 9, further comprising a user device having a camera or scanner configured to capture images for Know Your Customer (KYC) checks.

12. The system of claim 9, wherein said processing platform monitors the number of PPCCs comprised in the vending machine and automatically initiates re-stocking of the vending machine when said number falls below a predetermined level.

13. The system of claim 9, further comprising a product manager digital dashboard connected to said processing platform for monitoring one or more of: spending on the PPCC, PPCC registration, PPCC sales and PPCC stock levels.

14. A method for issuing a prepaid currency card (PPCC) from a vending machine, said method comprising:
taking payment from a user and initiating transmission of a payment received message to a controller, said message comprising a payment identification code (PIC);
reading an identification code (ID) of a PPCC held in a position in PPCC storage which is next to be dispensed from;
dispensing a PPCC from said PPCC storage in response to receipt of a dispense command from said controller; and
transmitting said PIC together with said card ID to a card issuer server.
